(19) United States
(12) Patent Application Publication
(10) Pub. No.: US 2025/0078594 A1
(43) Pub. Date: Mar. 6, 2025

(54) Biometric Information for Collecting a Shipment

(71) Applicants: Ralf Hormann, Bonn (DE); Martin Bossek, Brühl (DE); Lukas Beckedorff, Bonn (DE)

(72) Inventors: Ralf Hormann, Bonn (DE); Martin Bossek, Brühl (DE); Lukas Beckedorff, Bonn (DE)

(73) Assignee: Deutsche Post AG, Bonn (DE)

(21) Appl. No.: 18/814,885

(22) Filed: Aug. 26, 2024

(30) Foreign Application Priority Data
Aug. 28, 2023 (DE) 10 2023 123 067.0

(51) Int. Cl. G07C 9/00; G07C 9/25; G07C 9/27

(52) U.S. Cl. CPC G07C 9/00563; G07C 9/00571; G07C 9/00896; G07C 9/25; G07C 9/27; G07C 2009/0092

(57) ABSTRACT

A method includes obtaining authorization information. The authorization information authorizes collection of a shipment from a locker installation. The method includes obtaining biometric information. The biometric information represents at least one biometric feature of a person. The method includes determining authorization indication information, at least partially based on the authorization information and the biometric information. The authorization indication information indicates that the biometric information authorizes collection of the shipment from the locker installation. The method includes providing the authorization indication information and the biometric information.

### CROSS-REFERENCE TO RELATED PATENT APPLICATIONS

This patent application claims priority to German Application No. 10 2023 123 067.0, filed Aug. 28, 2023, the entire teachings and disclosures of which are incorporated herein by reference thereto.

### FIELD OF THE INVENTION

Exemplary embodiments of the present disclosure relate to methods, devices, systems and computer programs for the use of biometric information when collecting shipments from a locker installation.

### BACKGROUND OF THE INVENTION

Locker installations are used diversely in the form of lockbox or parcel locker installations, for example. One example of a locker installation is a parcel station, which a user may use for the purpose of receiving or shipping postal shipments. If a recipient wishes to collect a shipment stored in a locker installation, this conventionally requires authorization information (for example in the form of a collection code). This authorization information authorizes collection of the shipment and needs to be submitted for example in situ at the locker installation before a stored shipment is issued by the locker installation (for example by opening a compartment of the locker installation). Such a requirement for authorization information to collect a shipment may be disadvantageous, since the authorization information necessarily has to be carried by the recipient of the shipment at collection, and collection of the shipment is also made more difficult for a third person (for example to whom the recipient wishes to transfer the collection of the shipment).

### SUMMARY OF THE INVENTION

This therefore gives rise to the object, inter alia, of making the collection of a shipment from a locker installation more advantageous and, in particular, more flexible.

According to a first aspect of the present disclosure, what is disclosed is a method comprising the following:
obtaining authorization information, wherein the authorization information authorizes collection of a shipment from a locker installation;
obtaining biometric information, wherein the biometric information represents at least one biometric feature of a person;
determining authorization indication information, at least partially based on the authorization information and the biometric information, wherein the authorization indication information indicates that the biometric information authorizes collection of the shipment from the locker installation; and
providing the authorization indication information and the biometric information.

By way of example, the method according to the first aspect may be performed at least partially or completely by a user device (for example a smartphone).

Authorization information authorizes collection of a shipment from a locker installation, such that for example submission of the authorization information at the corresponding locker installation, following an inspection of the authorization information, leads to a specific compartment of the locker installation being opened, and the shipment may be removed from the compartment for collection. The authorization information may thus authorize (for example only) collection of a specific shipment, such that the authorization information loses its validity when this specific shipment is collected and does not authorize collection of further shipments from corresponding locker installations.

Authorization information may take a variety of forms. It may involve for example letters, numbers, symbols, patterns, bit sequences or the like. A combination of the aforementioned formats is also possible. By way of example, the authorization information may be an optical pattern (for example a QR code or a barcode) or be represented by an optical pattern. In particular, authorization information may be for example a code word (for example a code word chosen by a user or a device, for example randomly). Authorization information may additionally or instead also contain a user identifier, for example a customer number, personal details, a personal cryptographic key or similar information (for example uniquely assignable to a user). Authorization information may be displayable, inter alia, graphically, in a manner readable by humans and/or machines and/or able to be transmitted electronically and/or by radio.

Authorization information may for example be transmitted from the user device (for example a smartphone of the user wishing to collect a shipment from the locker installation) to the control unit of the locker installation. This transmission may be carried out for example by way of a radio connection (for example Bluetooth). In another example, the authorization information may be transmitted by way of an optical pattern, wherein the optical pattern is displayed on a screen of the user device for capture by a capture unit of the control unit of the locker installation. The optical pattern may be for example a QR code or a barcode and the capture unit may be for example a scanner for scanning corresponding patterns. In another example, the authorization information is transmitted by way of the authorization information being displayed on a screen of the user device for visual capture by a user of the user device, who then inputs the authorization information on an input unit of the control unit of the locker installation, in particular a keypad or a touch-sensitive screen. In this case, the authorization information may be displayed for example as an alphanumeric character string on the screen of the user device.

It may then be determined whether the authorization information obtained at the control unit of the locker installation authorizes collection of a shipment, such that the control unit of the locker installation may cause the opening and unlocking of the compartment of the locker installation (for example by actuating a corresponding lock control unit of the locker installation).

The authorization information may be obtained for example on the user device. This should be understood to mean that the authorization information is received for example from a backend server, or that the authorization information is captured by way of an image recording device of the user device. In a further example, the authorization information may be generated by the user device.

A biometric feature should be understood to mean for example a feature that uniquely identifies a person. Accordingly, such a biometric feature of a person is suitable for identifying and/or authenticating this person.

By way of example, a biometric feature of a person may be a facial feature of this person. A facial feature may be for example an eye position and/or an inter-eye distance, a nose shape and/or a nose position, a shape of the mouth and/or lip contours or a face shape (for example the proportions of the forehead, cheeks and chin). Other examples of biometric features are fingerprint features (for example a pattern of lines and swirls on the fingertips) or features of the human voice (for example a pitch, timbre and diction).

A biometric feature may for example be captured by the user device by way of at least one biometric sensor, wherein the at least one biometric sensor may be part of the user device.

Biometric information is obtained for example by determining the biometric information based on at least one of the previously captured biometric features. This determining may comprise one or more steps, such as for example processing the at least one biometric feature and/or encoding the biometric information based on the at least one biometric feature. Obtaining biometric information should accordingly be understood to mean for example determining the biometric information based on at least one biometric feature, wherein the obtaining may additionally comprise capturing the at least one biometric feature. In one example, the biometric information may comprise a model (for example a mathematical model, which describes a face of a person, for example), wherein the model is determined based on at least one previously captured biometric feature (for example a facial feature of a person). The biometric information may accordingly represent the at least one biometric feature or a plurality of biometric features.

The obtained biometric information may accordingly be understood as electronic information (for example as binary-coded electronic data) that is available for example in a computer-readable format for pieces of biometric information (for example in a specialized format for facial recognition purposes, such as ISO/IEC 19794-5 or ANSI INCITS 385).

Authorization indication information may be understood for example as an information element (for example a variable or an attribute as part of a data structure) that indicates, for specific biometric information, that this biometric information authorizes collection of a specific shipment from a locker installation. For example, the submission of the biometric information at a corresponding locker installation may accordingly lead, after the biometric information has been inspected, to a specific compartment of the locker installation being opened, and the shipment may be removed from the compartment for collection. If authorization indication information is determined for example based on biometric information and authorization information, then this determined authorization indication information indicates that the biometric information authorizes collection of that shipment for which the authorization information also authorizes collection.

The biometric information may accordingly be understood as further/additional/alternative authorization information. In one example, after the authorization indication information has been determined, the originally obtained authorization information may lose its validity and thus no longer be used to collect the shipment. In other examples, the originally obtained authorization information retains its validity after the authorization indication information has been determined, such that either the authorization information or the biometric information may be used to collect the shipment.

Providing the authorization indication information and the biometric information may be understood to mean for example that the user device transmits the authorization indication information and the biometric information to a backend server (for example via an interface to a cellular mobile radio system, a DSL interface or a local area network (LAN) interface, by way of which the user device is able to communicate with the backend server via a communication connection).

According to a second aspect of the present disclosure, what is disclosed is a method comprising the following:
obtaining biometric information, wherein the biometric information represents at least one biometric feature of a person;
determining whether the biometric information authorizes collection of a shipment; and
if it is determined that the biometric information authorizes collection of a shipment, causing opening of a compartment of a locker installation in which the shipment is stored.

By way of example, the method according to the second aspect may be performed at least partially or completely by a control unit of a locker installation or by a backend server.

If the obtaining of biometric information is performed by a control unit of a locker installation, the obtaining may comprise capturing the at least one biometric feature represented by the biometric information by way of a biometric sensor of the locker installation. The biometric feature may in this case be captured as described above with regard to the method according to the first aspect. The biometric information may then be obtained at the control unit of the locker installation, as described above with regard to the method according to the first aspect, and for this purpose for example be determined based on the captured biometric feature.

If the obtaining of biometric information is performed by a backend server, the obtaining may comprise receiving the biometric information on the backend server from a control unit of a locker installation (for example via a communication interface of the control unit that enables access to the Internet or to some other network to which the backend server is connected). In such a case, the biometric information is obtained for example before transmission to the backend server at the control unit of the locker installation, by virtue for example of the biometric feature represented by the biometric information being captured by at least one biometric sensor of the locker installation.

Determining whether the biometric information authorizes collection of a shipment may for example comprise determining whether authorization indication information is available indicating that the obtained biometric information authorizes collection of a shipment. Such available authorization indication information may for example be authorization indication information that has previously been determined on a user device, as described above for the method according to the first aspect.

By way of example, the determining whether the obtained biometric information authorizes collection of a shipment may comprise comparing the obtained biometric information with at least one already available piece of biometric information (for example a plurality of already available pieces of biometric information). For example, it is determined here whether the obtained biometric information matches one of the already available pieces of biometric information. If the obtained biometric information matches already available biometric information, it is then determined for example whether authorization indication information is available indicating that the already available biometric information matching the obtained biometric information authorizes collection of a shipment. If such authorization indication information is available, it is determined for example that the obtained biometric information authorizes collection of a shipment.

By way of example, the obtained biometric information may match available biometric information if the biometric feature represented by the obtained biometric information matches the biometric feature represented by the available biometric information. Such a match may also be present for example if the respective biometric features match one another within a predetermined tolerance.

If the determining whether the biometric information authorizes collection of a shipment is performed by the control unit of a locker installation, the control unit may for example compare the obtained biometric information with at least one already available piece of biometric information, wherein the already available biometric information may be stored for example in a data memory of the control unit, and is retrieved from this data memory for the purpose of the comparison. In another example, already available biometric information may be requested by the control unit from a backend server, in response to which the requested already available biometric information is transmitted from the backend server to the control unit and compared with the obtained biometric information at the control unit. In another example, the determining may comprise transmitting the obtained biometric information from the control unit of the locker installation to the backend server, wherein the backend server compares the transmitted biometric information with at least one already available piece of biometric information on the backend server and then sends a result of the comparison back to the control unit. It may then be determined at the control unit, based on the received result of the comparison, that the obtained biometric information authorizes collection of a shipment if the received result indicates that the obtained biometric information matches already available biometric information on the backend server and authorization indication information is also available indicating that the already available biometric information authorizes collection of a shipment.

If the determining whether the biometric information authorizes collection of a shipment is performed by the backend server, the backend server may compare the biometric information previously received from the control unit of the locker installation with at least one already available piece of biometric information on the backend server and thus determine whether authorization indication information is available indicating that the obtained biometric information authorizes collection of a shipment.

Opening of a compartment of a locker installation is caused when (for example only when) it is determined that the obtained biometric information authorizes collection of a shipment. This is the case for example if it has been determined previously that authorization indication information is available indicating that the obtained biometric information authorizes collection of a shipment. If for example it is determined that the obtained biometric information does not authorize collection of a shipment, it is possible to output information (for example via a user interface of the control unit of the locker installation) indicating that there is no shipment for collection in the locker installation for the person for whom the obtained biometric information represents a biometric feature.

If the opening is caused by the control unit of a locker installation, the causing of the opening may for example comprise actuating a corresponding lock control unit of a compartment of the locker installation in which the shipment in question is stored. The lock control unit is actuated here for example such that it opens the compartment of the locker installation (for example by unlocking a lock of the compartment).

If the opening is caused by a backend server, the causing of the opening may for example comprise the backend server sending a command to the control unit of a locker installation to open a specific compartment of this locker installation. In response thereto, this control unit for example actuates a corresponding lock control unit so that the compartment is opened. By way of example, causing the opening in such a case comprises the backend server first determining the locker installation in which the shipment for which the obtained biometric information authorizes collection is stored, and then sending an opening command to the control unit of the determined locker installation.

By way of example, after the opening has been caused, the obtained biometric information, along with the available biometric information and the available authorization indication information, is deleted.

According to a third aspect of the present disclosure, what is disclosed is a method comprising the following:
providing authorization information, wherein the authorization information authorizes collection of a shipment from a locker installation;
obtaining authorization indication information and biometric information, wherein the authorization indication information is determined, before the obtaining, at least partially based on the authorization information and the biometric information, and wherein the authorization information indicates that the biometric information authorizes collection of the shipment from the locker installation; and
providing the authorization indication information and the biometric information.

By way of example, the method according to the third aspect may be performed at least partially or completely by a backend server.

The providing of the authorization information should be understood to mean for example that the backend server makes the authorization information available to a person (for example the recipient of the shipment for which the authorization information authorizes collection), such that the person is authorized to collect the shipment from a locker installation by way of the authorization information. By way of example, the backend server sends the authorization information to a user device of the person to be authorized (for example via a communication connection between the backend server and the user device). In a further example, the backend server sends the authorization information to a portable delivery agent device (for example the delivery agent device of the delivery agent that previously stored the shipment in question in a locker installation). In such a case, the authorization information may be printed for example in the form of a barcode by the delivery agent device (for example a hand-held device equipped with a scanner and printer), wherein the printed barcode (for example printed on a collection card) is then inserted for example by the delivery agent into a letterbox of the person who is the recipient of the shipment for which the authorization information authorizes collection.

By way of example, the authorization information provided by the backend server is obtained on a user device, as described with regard to the method according to the first aspect. Accordingly, authorization indication information is determined at a later point in time on the user device based on the obtained authorization information and received biometric information. This authorization indication information, together with the biometric information, for example, is transmitted back from the user device to the backend server, such that the authorization indication information and the biometric information are obtained on the backend server in accordance with the method of the third aspect.

After obtaining authorization indication information and biometric information, the backend server provides for example the obtained authorization indication information and the obtained biometric information. The provided authorization indication information and biometric information may be understood hereinafter as available biometric information and as available authorization indication information.

The providing of the authorization indication information and of the biometric information may for example comprise storing these pieces of information in a data memory of the backend server. In a further example, the providing of the authorization indication information and of the biometric information may comprise these pieces of information being sent to the control unit of a locker installation, wherein these pieces of information are then stored in a data memory of this control unit. For this purpose, the backend server may for example first determine the locker installation in which the shipment for which the authorization indication information indicates that the biometric information authorizes collection has been stored beforehand. The backend server may then send both pieces of information to the control unit of the determined locker installation. At this locker installation, for example, a method according to the second aspect may be carried out thereafter, in the course of which the stored shipment is collected.

According to the above-described aspects of the present disclosure, a user, as shipment recipient, may advantageously capture one or more biometric features of their person (for example a facial feature) by way of their user device (for example a smartphone) based on obtained conventional authorization information for the collection of a shipment. In response thereto, the user device determines that, in addition or as an alternative to the conventional authorization information, biometric information representing the captured biometric feature authorizes collection of the shipment. The user may then accordingly, at the locker installation in question, have this biometric feature captured by corresponding sensors of the locker installation, such that the corresponding shipment is issued following an inspection. It is thus advantageously no longer necessary to carry and submit the conventional authorization information at the locker installation in order to issue a stored shipment.

Instead of conventional authorization information, it is advantageously sufficient to capture a biometric feature in order to collect a stored shipment, such that a recipient does not have to carry any additional pieces of information or proof in order to collect the shipment in question. Advantageously, the biometric information may authorize collection of a specific shipment, such that said information is able to be deleted from all data memories (for example data memories of the control unit of the locker installation or of the backend server) after this shipment has been collected. This thus advantageously ensures that the (for example sensitive) biometric information is stored only temporarily up to the time of shipment collection.

According to each of the above-described aspects of the present disclosure, the following are furthermore disclosed in each case:
A computer program, comprising program instructions that cause a processor to perform and/or to control the method according to the respective aspect of the present disclosure when the computer program runs on the processor. In this specification, a processor should be understood to mean, inter alia, control units, microprocessors, microcontrol units such as microcontrollers, digital signal processors (DSP), application-specific integrated circuits (ASICs) or field-programmable gate arrays (FPGAs). Here, either all of the steps of the method may be controlled, or all of the steps of the method may be performed, or one or more steps may be controlled and one or more steps may be performed. The computer program may be distributable for example via a network such as the Internet, a telephone or mobile radio network and/or a local area network. The computer program may be at least partially software and/or firmware of a processor. It may equally be implemented at least partially as hardware. The computer program may be stored for example on a computer-readable storage medium, for example a magnetic, electrical, optical and/or other type of storage medium. The storage medium may be for example part of the processor, for example a (non-volatile or volatile) program memory of the processor or a part thereof. The storage medium may be for example a substantive or physical storage medium.
A device, configured to perform and/or control the method according to the respective aspect of the present disclosure or comprising respective means for performing and/or controlling the steps of the method according to the respective aspect of the present disclosure. Here, either all of the steps of the method may be controlled, or all of the steps of the method may be performed, or one or more steps may be controlled and one or more steps may be performed. One or more of the means may also be implemented and/or controlled by the same unit. For example, one or more of the means may be formed by one or more processors.
A device, comprising at least one processor and at least one memory that includes program code, wherein the memory and the program code are configured to cause a device having the at least one processor to perform and/or control at least the method according to the respective aspect of the present disclosure. Here, either all of the steps of the method may be controlled, or all of the steps of the method may be performed, or one or more steps may be controlled and one or more steps may be performed.

Further advantages of the exemplary aspects of the present disclosure are described below on the basis of exemplary embodiments, the disclosure of which is intended to be equally applicable to all aspects of the present disclosure.

In one exemplary embodiment of the method according to the first aspect, the authorization information is represented by a collection code.

By way of example, the authorization information is embodied by a collection code, such that the authorization information is able to be obtained by capturing the collection code. In another example, the authorization information is represented by more than one collection code, for example by virtue of a new collection code being generated repeatedly at certain time intervals based on available authorization information on a user device, the new collection code representing the authorization information in each case on a time-limited basis in order to increase the integrity of the collection code.

A collection code may be understood to mean for example a code, wherein this code, when it is submitted at a locker installation, authorizes collection of a stored shipment (for example, the submission of the collection code causes opening of a compartment, such that the stored shipment is able to be removed). The collection code, which represents authorization information, may take a variety of forms. For example, a collection code may comprise letters, numbers and/or optical patterns (for example a QR code or a barcode). A collection code may be submitted for example at a locker installation by virtue of a user manually entering the collection code, which consists for example of numbers and/or letters, on an input unit of a control unit of the locker installation (for example a keypad or a touch-sensitive screen with a screen keypad) or by virtue of the collection code being transmitted from the user device to the control unit of the locker installation by way of a radio connection (for example Bluetooth). In other examples, in which the collection code is embodied by an optical pattern (for example a QR code or a barcode), the collection code may be submitted for example at the locker installation by virtue of a control unit of the locker installation having a capture unit, such as for example a scanner, that is able to capture pieces of information optically. The capture unit may thus for example capture the collection code in the form of a barcode or a QR code from a screen of the user device or from a collection card.

In one exemplary embodiment of the method according to the first aspect, the obtaining of the authorization information furthermore comprises:
receiving the authorization information from a backend server; or
causing capturing of the authorization information by an image recording device of a user device.

By way of example, the authorization information may be received on the user device from a backend server (for example via an interface to a cellular mobile radio system, a DSL interface or a local area network (LAN) interface, by way of which the user device is able to communicate with the backend server via a communication connection). For example, the backend server sends the authorization information to the user device after the authorization information has been generated on the backend server. By way of example, the user of the user device is informed, via a user interface of the user device after receiving the authorization information, that authorization information is available and authorizes the user to collect a shipment addressed to them from a locker installation.

In another example, the authorization information is captured on the user device by way of an image recording device (for example a camera) of the user device. This should be understood to mean for example that a camera of the user device captures (for example photographs) a collection code (for example a barcode or a QR code) present in printed form, and the authorization information represented by the collection code is captured by capturing the collection code. The capturing of the collection code may also comprise, in addition to photographing the collection code, subsequently implementing a recognition algorithm, wherein the recognition algorithm recognizes the authorization information represented by the collection code. The collection code may for example be printed on a collection card, wherein the collection card is inserted beforehand, by a delivery agent, into a letterbox of the person who is the recipient of the shipment for which the authorization information authorizes collection. In such a case, the authorization information may for example have been printed in the form of a barcode by a delivery agent device of the delivery agent (for example a hand-held device equipped with a scanner and printer) after the delivery agent stored the shipment in a locker installation.

In one exemplary embodiment of the method according to the first aspect, the obtaining of the biometric information furthermore comprises:
causing capturing of the at least one biometric feature represented by the biometric information by one or more biometric sensors of the user device.

Causing capturing of the at least one biometric feature may be understood to mean for example that the user device actuates at least one biometric sensor such that the at least one biometric sensor, in response thereto, captures the at least one biometric feature. For example, the user device then determines the biometric information based on the at least one captured biometric feature.

By way of example, a biometric sensor may be embodied by a camera (which for example comprises one or more image sensors) of the user device, wherein the camera for example captures images of a face from different angles and distances. Based on the captured images, one or more facial features may be determined, for example by way of image processing (for example an image analysis algorithm). Furthermore, a camera (for example an infrared camera) of the user device may for example capture a three-dimensional shape of a face, for example by virtue of a dot pattern first being projected onto the face and the camera then capturing the reflected dot pattern. In a further example, a biometric sensor may be embodied by a fingerprint sensor of the user device (which for example comprises one or more image sensors, capacitive sensors, thermal sensors and/or pressure sensors). In a further example, a biometric sensor may be embodied by a microphone of the user device, wherein the microphone for example picks up a spoken voice and the picked-up audio signals are analyzed by way of audio processing in order to determine characteristic vocal features such as pitch or frequency patterns.

In one exemplary embodiment of the method according to the first aspect, the obtaining of the biometric information furthermore comprises:
requesting the biometric information from a further user device;
receiving the requested biometric information from the further user device.

In one example, the user device, which obtained authorization information in a previous step, makes a request to a further user device. For example, the user device, for this purpose, sends a request message to the further user device (for example via an interface to a cellular mobile radio system, a DSL interface, a local area network (LAN) interface, or a further radio interface such as for example WLAN or Bluetooth, by way of which the user device communicates with the further user device via a communication connection). The sent request message indicates for example that biometric information is requested from the further user device, wherein the requested biometric information represents at least one biometric feature of a person.

Similarly to the user device, the further user device may also be understood for example as a smartphone, but it may also be embodied by other forms of electronic end-user devices (for example desktop computer, laptop or tablet). By way of example, a user of the further user device differs from the user of the user device.

By way of example, the step of requesting the biometric information from a further user device is triggered by a user action on the user device, wherein the further user device is determined for example based on the user action. The request to a further user device is thus triggered for example only if the user of the device has initiated this request.

By way of example, the further user device, in response to the request obtained from the user device, obtains the requested biometric information. This obtaining may comprise capturing at least one biometric feature by one or more biometric sensors of the further user device, wherein the further user device for example determines the requested biometric information based on the at least one captured biometric feature such that the requested biometric information represents the at least one biometric feature captured by the further user device. The capturing of the at least one biometric feature by the further user device may be performed for example as described above for the capturing of the at least one biometric feature by the user device.

After for example the further user device has determined the requested biometric information, the further user device may send the requested biometric information to the user device that originally requested the biometric information (for example via that communication connection via which the request for the biometric information was previously sent to the further user device).

By way of example, the user device, after it has received the requested biometric information from the further user device, subsequently determines the authorization indication information, at least partially based on the obtained authorization information and the biometric information received from the further user device.

Advantageously, making a request to a further user device makes it possible to obtain biometric information representing a biometric feature of a third person (that is to say a user of the further user device). For example, this third person may be a person to whom the original recipient of the stored shipment (that is to say a user of the user device) would like to transfer the collection of the stored shipment. By capturing a biometric feature from this third person and then determining authorization indication information indicating that biometric information representing the biometric feature of the third person authorizes collection of the shipment, a third person is able to be flexibly authorized by the original recipient of the conventional authorization information to collect the shipment. Advantageously, it is not necessary for the third person to obtain the conventional authorization information and to submit it when collecting the shipment at the locker installation. At the same time, the described transfer of the collection authorization is secure against attempted fraud, since the transfer is carried out via the user device of the original recipient of the conventional authorization information and is thus under the control of the original recipient, who is able to decide whether and from which further user device biometric information is requested.

In one exemplary embodiment of the method according to the first aspect, the providing of the authorization indication information and of the biometric information furthermore comprises:
transmitting the biometric information and the authorization indication information to a backend server.

By way of example, the user device transmits the authorization indication information and the biometric information to a backend server (for example via an interface to a cellular mobile radio system, a DSL interface or a local area network (LAN) interface, by way of which it is able to communicate with the backend server via a communication connection). The authorization indication information and biometric information transmitted to the backend server may be understood hereinafter as available biometric information and as available authorization indication information.

In one exemplary embodiment of the method according to the second aspect, the obtaining of the biometric information furthermore comprises:
causing capturing of the at least one biometric feature represented by the biometric information by one or more biometric sensors of the locker installation.

Causing capturing of the at least one biometric feature may be understood to mean for example that the control unit of the locker installation actuates at least one biometric sensor of the locker installation such that the at least one biometric sensor, in response thereto, captures the at least one biometric feature. By way of example, the control unit of the locker installation then determines the biometric information based on the at least one captured biometric feature.

In another example, the capturing may be caused by a backend server, wherein the backend server for example sends a command to the control unit of a locker installation to capture at least one biometric feature. In response thereto, this control unit for example actuates at least one biometric sensor of the locker installation such that this biometric sensor captures a biometric feature.

By way of example, a biometric sensor may be embodied by a camera (which for example comprises one or more image sensors) of the locker installation, wherein the camera for example captures images of a face from different angles and distances. Based on the captured images, one or more facial features may be determined, for example by way of image processing (for example an image analysis algorithm). Furthermore, a camera (for example an infrared camera) of the locker installation may for example capture a three-dimensional shape of a face, for example by virtue of a dot pattern first being projected onto the face and the camera then capturing the reflected dot pattern. In a further example, a biometric sensor may be embodied by a fingerprint sensor of the locker installation (which for example comprises one or more image sensors, capacitive sensors, thermal sensors and/or pressure sensors). In a further example, a biometric sensor may be embodied by a microphone of the locker installation, wherein the microphone for example picks up a spoken voice and the picked-up audio signals are analyzed by way of audio processing in order to determine characteristic vocal features such as pitch or frequency patterns.

In one exemplary embodiment of the method according to the second aspect, the determining whether the biometric information authorizes collection of a shipment furthermore comprises:
determining whether authorization indication information is available indicating that the obtained biometric information authorizes collection of a shipment.

By way of example, the determining whether authorization indication information is available indicating that the obtained biometric information authorizes collection of a shipment comprises comparing the obtained biometric information with at least one already available piece of biometric information (for example a plurality of already available pieces of biometric information). For example, it is determined here whether the obtained biometric information matches one of the already available pieces of biometric information. If the obtained biometric information matches already available biometric information, it is then determined for example whether authorization indication information is available indicating that the already available biometric information matching the obtained biometric information authorizes collection of a shipment. If such authorization indication information is available, it is determined for example that the obtained biometric information authorizes collection of a shipment.

By way of example, the obtained biometric information may match available biometric information if the biometric feature represented by the obtained biometric information matches the biometric feature represented by the available biometric information. For example, such a match may also be present if the respective biometric features match one another within a predetermined tolerance. Such a tolerance may be required for example because the biometric feature represented by the obtained biometric information was captured by a biometric sensor of a locker installation and the biometric feature represented by the available biometric information was captured by a biometric sensor of a user device, wherein the biometric sensors of the user device and of the locker installation for example differ from one another and capture the same biometric feature of a person differently.

If the determining whether authorization indication information is available indicating that the obtained biometric information authorizes collection of a shipment is performed by the control unit of a locker installation, the control unit may for example compare the obtained biometric information with at least one already available piece of biometric information, wherein the already available biometric information may be stored for example in a data memory of the control unit, and is retrieved from this data memory for the purpose of the comparison. In another example, already available biometric information may be requested by the control unit from a backend server, in response to which the requested already available biometric information is transmitted from the backend server to the control unit and compared with the obtained biometric information at the control unit. In another example, the determining may comprise transmitting the obtained biometric information from the control unit of the locker installation to the backend server, wherein the backend server compares the transmitted biometric information with at least one already available piece of biometric information on the backend server and then sends a result of the comparison back to the control unit. It may then be determined at the control unit, based on the received result of the comparison, that the obtained biometric information authorizes collection of a shipment if the received result indicates that the obtained biometric information matches already available biometric information on the backend server and authorization indication information is also available indicating that the already available biometric information authorizes collection of a shipment.

If the determining whether authorization indication information is available indicating that the obtained biometric information authorizes collection of a shipment is performed by the backend server, the backend server may compare the biometric information previously received from the control unit of the locker installation with at least one already available piece of biometric information on the backend server and thus determine whether authorization indication information is available indicating that the obtained biometric information authorizes collection of a shipment.

In one exemplary embodiment of the method according to the second aspect, causing the opening of the compartment furthermore comprises:
determining, at least partially based on the available authorization indication information, the compartment of the locker installation in which the shipment authorized for collection by the biometric information is stored.

By way of example, the authorization indication information indicates whether biometric information authorizes collection of a shipment stored in a locker installation. This in particular concerns any shipment the collection of which is authorized by original authorization information for collection. For example, the authorization indication information indicates, by way of a shipment identifier, the specific shipment for which the authorization indication information authorizes collection. Furthermore, for example, for such a shipment identified by the indicated identifier, a data memory stores the information as to which compartment of which locker installation the specific shipment has been stored in. It is thereby possible, at least partially based on the authorization indication information, to determine the compartment of a locker installation in which the shipment authorized for collection by the biometric information is stored.

The determination of the compartment of the locker installation in which the shipment authorized for collection by the biometric information is stored may be performed either by a backend server or by a control unit of the locker installation. In this case, for example, a corresponding data memory, both on the backend server and on the control unit of the locker installation, may store the information as to which compartment of the locker installation which shipment has been stored in.

In one exemplary embodiment of the method according to the third aspect, the providing of authorization information comprises transmitting the authorization information to a user device, wherein the obtaining of authorization indication information and of biometric information comprises receiving the authorization indication information and the biometric information from the user device, and wherein the providing of the authorization indication information and of the biometric information comprises transmitting the authorization indication information and the biometric information to a control unit of a locker installation.

By way of example, a backend server transmits the provided authorization information to a user device on which the authorization information is received, as described with regard to the method according to the first aspect, and is used to determine authorization indication information. By way of example, the backend server receives the authorization indication information and the biometric information from the user device, which transmits both pieces of information to the backend server as described with regard to the method according to the first aspect. By way of example, the authorization indication information and the biometric information are then transmitted from the backend server to a control unit of a locker installation, at which both pieces of information are received as described with regard to the method according to the second aspect.

In one exemplary embodiment of the methods according to the various aspects, the at least one biometric feature of the person is a facial feature of the person.

According to a further aspect of the present disclosure, what is disclosed is a system comprising at least a device according to the first aspect, a device according to the second aspect and a device according to the third aspect.

For example, the device according to the first aspect is a user device (for example a smartphone), the device according to the second aspect is a control unit of the locker installation or a backend server, and the device according to the third aspect is a backend server. By way of example, the system may comprise further devices and/or components of devices.

The above-described exemplary embodiments and exemplary configurations of all aspects of the present disclosure should also be understood as disclosed in all combinations with one another. In particular, the disclosure of a method step is also deemed to be disclosure of means for performing the respective method step. Likewise, the disclosure of means for performing a method step is also deemed to be disclosure of the method step itself.

Further advantageous exemplary configurations of the present disclosure may be gathered from the following detailed description of some exemplary embodiments, in particular in association with the figures. The accompanying figures are however only intended for the purpose of elucidation, but do not serve for determining the scope of protection of the claims. The accompanying drawings are not necessarily true to scale and are intended to only reflect the general concept of the present invention by way of example. In particular, features which are included in the figures are in no way intended to be considered a necessary part of the present invention.

### BRIEF DESCRIPTION OF THE DRAWINGS

In the figures:

FIG. 1 shows a schematic illustration of one exemplary embodiment of a system according to one aspect of the present disclosure;

FIG. 2 shows a flowchart of one exemplary embodiment of a method according to the first aspect of the present disclosure;

FIGS. 3a and 3b show schematic illustrations of one exemplary environment in which a method according to the first aspect of the present disclosure takes place;

FIG. 4 shows a flowchart of one exemplary embodiment of a method according to the second aspect of the present disclosure;

FIG. 5 shows a schematic illustration of one exemplary environment in which a method according to the second aspect of the present disclosure takes place;

FIG. 6 shows a flowchart of one exemplary embodiment of a method according to the third aspect of the present disclosure;

FIG. 7 shows a schematic illustration of one exemplary embodiment of a user device according to the first aspect of the present disclosure;

FIG. 8 shows a schematic illustration of one exemplary embodiment of a control unit of a locker installation according to the second aspect of the present disclosure;

FIG. 9 shows a schematic illustration of one exemplary embodiment of a backend server according to the second or third aspect of the present disclosure; and

FIG. 10 shows exemplary embodiments of storage media.

### DETAILED DESCRIPTION OF THE INVENTION

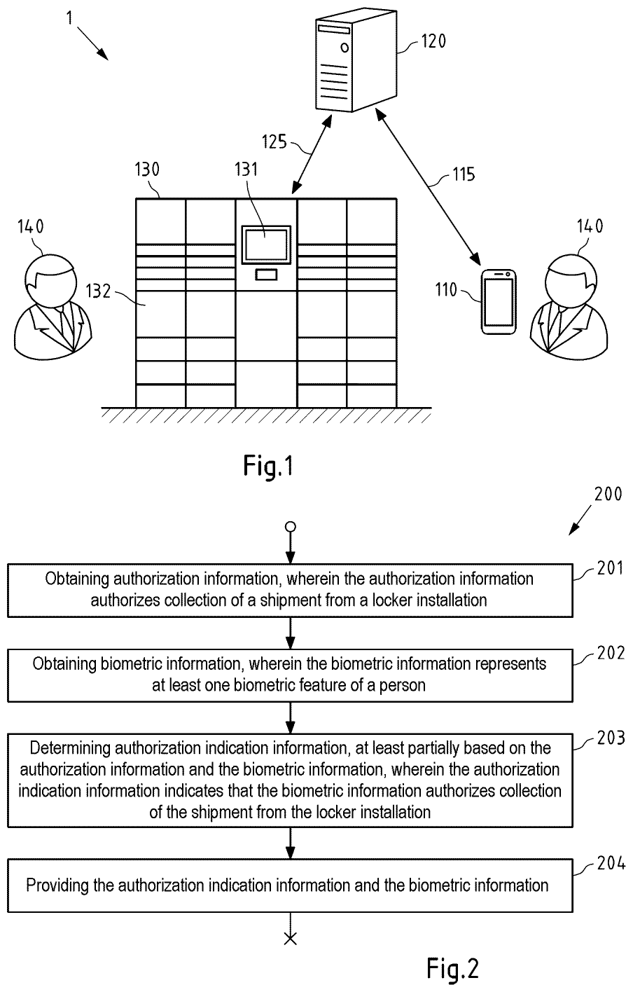

FIG. 1 shows a schematic illustration of one exemplary embodiment of a system 1 according to one aspect of the present disclosure.

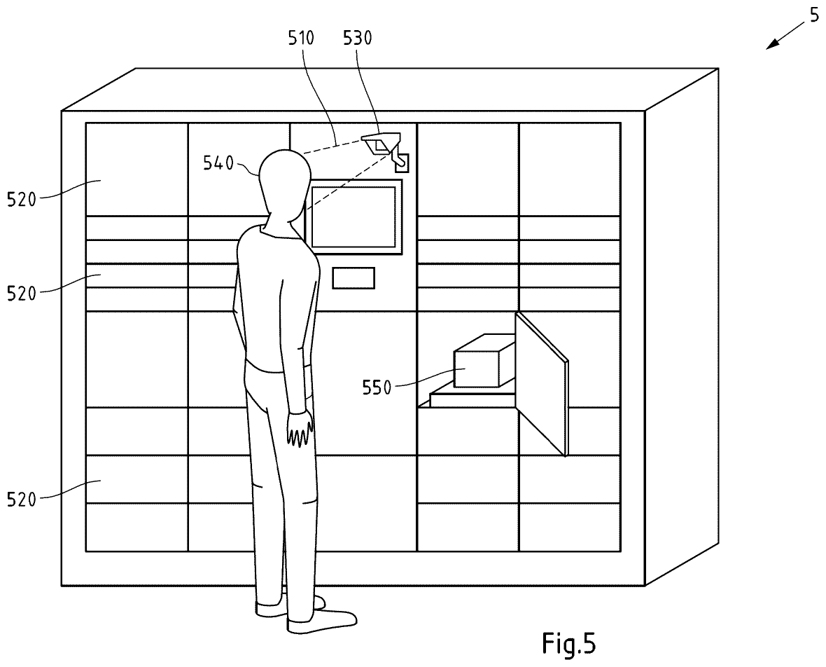

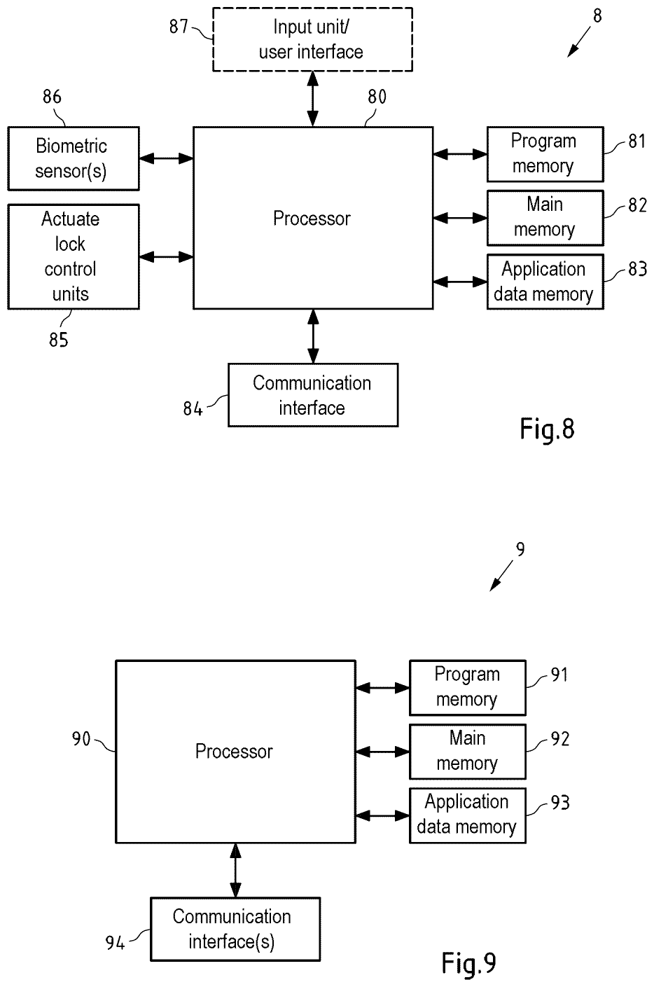

The system 1 comprises for example a locker installation 130 (for example the locker installation 5 illustrated in FIG. 5) comprising a control unit 131 of the locker installation 130 (for example the control unit illustrated in FIG. 8), a backend server 120 (for example the backend server 9 illustrated in FIG. 9) and a user device 110 (for example the user device 7 illustrated in FIG. 7), which should be understood, by way of example, as a user device of a user 140 who wishes to collect a shipment stored in the locker installation 130.

The user device 110 is configured in particular for remote communication, that is to say it has for example an interface to a cellular mobile radio system, a DSL interface or a local area network (LAN) interface, by way of which it is able to communicate with the backend server 120 via the communication connection 115. The user device 110 may be understood for example as a smartphone, but it may also be embodied by other forms of electronic end-user devices (for example desktop computer, laptop or tablet).

The control unit 131 of the locker installation 130 is by way of example also configured with at least one communication interface for communication with the backend server 120, that is to say has for example a communication interface that enables access to the Internet or to some other network to which the backend server 120 is connected. The control unit 131 is thus configured in particular for remote communication, that is to say has for example an interface to a cellular mobile radio system, a DSL interface or a local area network (LAN) interface, by way of which it is able to communicate with the backend server 120 via the communication connection 125.

The backend server 120 may manage and/or communicate with for example a plurality of locker installations including the locker installation 130 and/or a plurality of users including the user 140. The backend server 120 may for example communicate with the control unit 131 of the locker installation 130 via a communication connection 125.

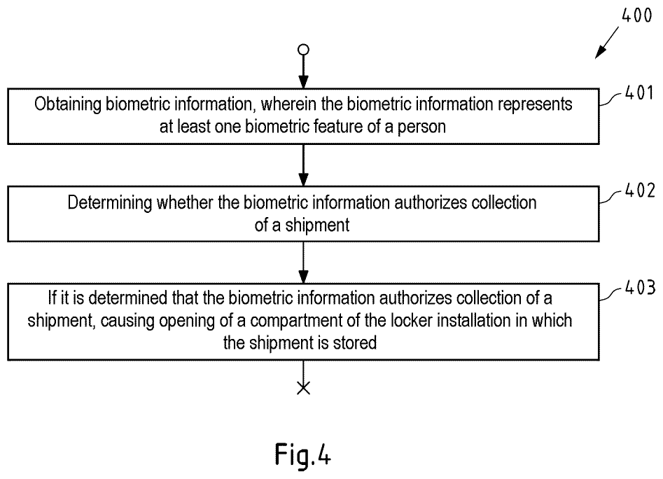

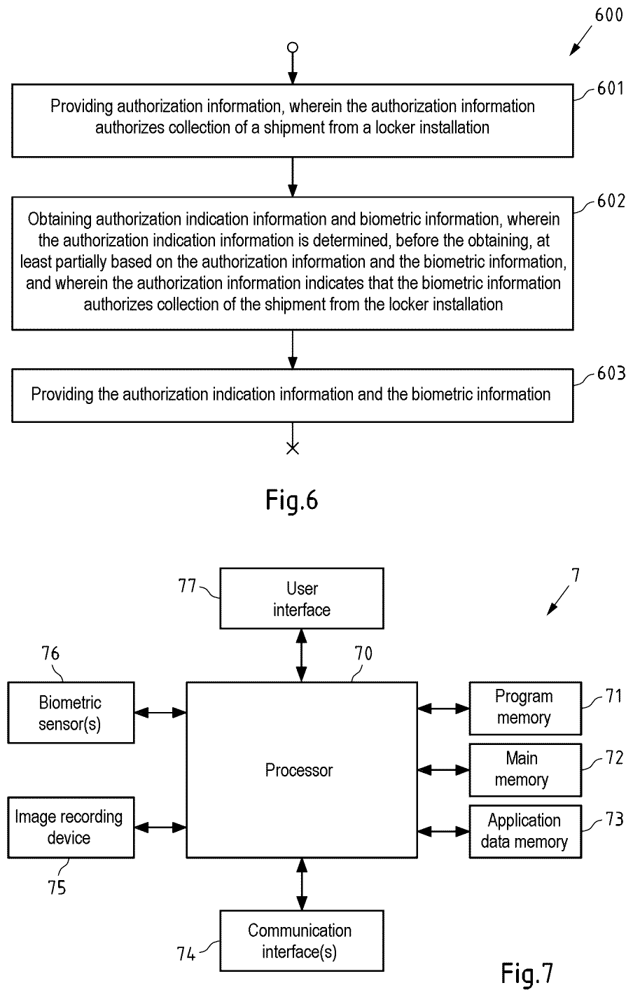

By way of example, the illustrated user 140 wishes to collect a shipment addressed to the user 140, the shipment having been stored in the locker installation 130 in the course of the shipment delivery, from the locker installation 130. The methods according to the various aspects of the present disclosure for the purpose of such collection are described below with reference to FIG. 2, FIG. 4 and FIG. 6.

FIG. 2 shows a flowchart of one exemplary embodiment of a method 200 according to the first aspect of the present disclosure. The method 200 is described below by way of example with reference to the system 1 illustrated in FIG. 1.

Step 201 is that of obtaining authorization information, wherein the authorization information authorizes collection of a shipment from a locker installation.

By way of example, the smartphone 110, as user device, receives authorization information from the backend server 120 via the communication connection 115, wherein the authorization information authorizes collection of a shipment that has been stored beforehand in the locker installation 130. This shipment is addressed to the person 140, who is able to have the authorization information, represented by a QR code, displayed on their smartphone 110. In the case of shipment collection, the person 140 may submit the QR code at the locker installation 130, such that it is captured by a scanner of a control unit 131, and the control unit 131 causes the opening of a corresponding compartment.

In another example, the person 140 obtains a collection card having a printed barcode that represents the authorization information. The person 140 then uses the camera of their smartphone 110 to capture the barcode, as a result of which the authorization information is obtained on the smartphone 110.

Step 202 is that of obtaining biometric information, wherein the biometric information represents at least one biometric feature of a person.

By way of example, a camera or a fingerprint sensor of the smartphone 110 captures a biometric feature of the person 140 (for example a facial feature or a fingerprint of the person 140), and the smartphone 110 then determines biometric information based on the captured biometric feature.

Step 203 is that of determining authorization indication information, at least partially based on the authorization information and the biometric information, wherein the authorization indication information indicates that the biometric information authorizes collection of the shipment from the locker installation.

By way of example, the smartphone 110 determines authorization indication information in step 203, based on the authorization information obtained in step 201 and the biometric information obtained in step 202, wherein the authorization indication information indicates that the biometric information obtained in step 202 authorizes collection of the shipment addressed to the person 140 from the locker installation 130. For example, the biometric information may in this case only authorize collection of the specific shipment also authorized by the authorization information obtained in step 201.

Step 204 is that of providing the authorization indication information and the biometric information.

By way of example, the smartphone 110 transmits the authorization indication information determined in step 203 and the biometric information obtained in step 202 to the backend server 120 via the communication connection 115.

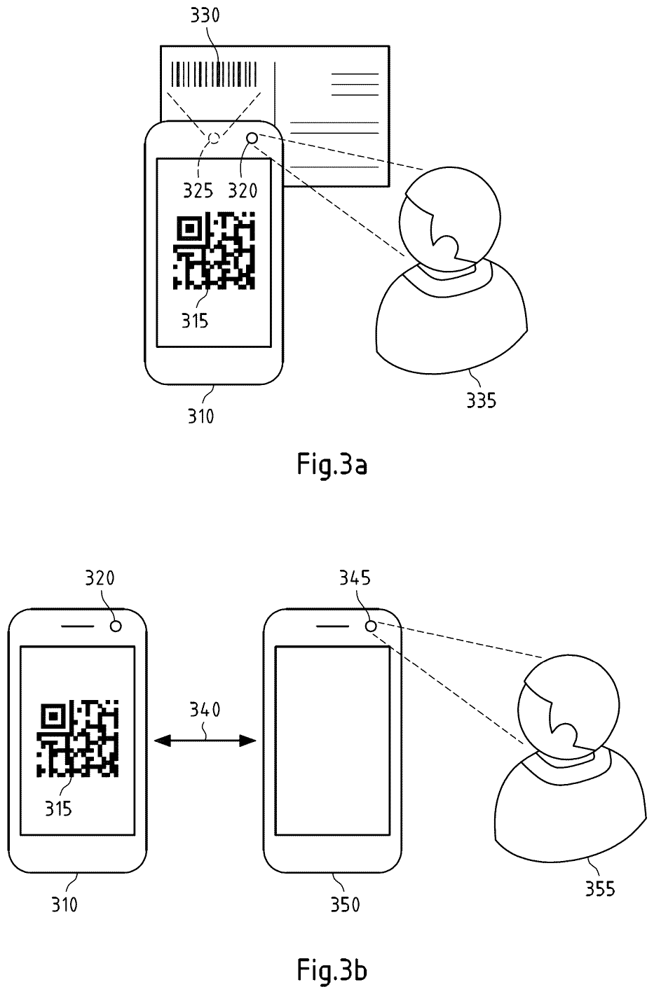

FIG. 3a and FIG. 3b show schematic illustrations of one exemplary environment in which a method according to the first aspect of the present disclosure takes place.

FIG. 3a and FIG. 3b show, by way of example, a smartphone 310, which should be understood as a user device and may correspond to the smartphone 110 as part of the system 1 illustrated in FIG. 1. The smartphone 310 is operated here by a user 335, who may correspond to the person 140 within the system 1. In the environment illustrated by way of example in FIG. 3a and FIG. 3b, for example, the method 200 illustrated in FIG. 2 may take place as described below.

First, the smartphone 310 receives authorization information, which is embodied by a collection code 330 (for example a barcode) (cf. step 201). The authorization information authorizes the person 335 to collect a shipment from a locker installation. As illustrated by way of example in FIG. 3a, the authorization information is obtained on the smartphone 310 of the person 335 by virtue of the collection code 330 printed on a collection card being captured by a camera 325 of the smartphone 310, such that the smartphone 310 obtains the authorization information represented by the collection code 330. In a further example, the smartphone 310 receives the authorization information (which is represented for example by a QR code 315) from a backend server (for example via an interface to a cellular mobile radio system).

Next, a further camera 320 of the smartphone 310, that is to say a biometric sensor, captures a facial feature of the person 335 (cf. step 202), wherein the smartphone 310, based on the captured facial feature, determines biometric information representing the captured facial feature (cf. step 203). Using this biometric information and the authorization information, the smartphone 310 determines authorization indication information indicating that the biometric information authorizes collection of the shipment from a locker installation.

In addition to the smartphone 310, FIG. 3b illustrates a smartphone 350 as an exemplary further user device. In one example, the smartphone 310 on which the authorization information represented by the QR code 315 was previously obtained makes a request to the smartphone 350. For this purpose, the smartphone 310 sends a request message to the smartphone 350 via the communication connection 340 (for example by way of an interface to a cellular mobile radio system, a WLAN interface or a Bluetooth interface). The sent request message indicates that biometric information is requested from the smartphone 350, wherein the requested biometric information represents at least one biometric feature of the person 355, who is different from the person 335. The step of requesting the biometric information on the smartphone 350 is triggered by a user action by the person 335 on the smartphone 310, wherein the smartphone 350 is determined based on the user action. The request to the smartphone 350 is thus triggered only if the person 335 has initiated this request.

By way of example, the smartphone 350, in response to the request received from the smartphone 310, obtains the requested biometric information. This obtaining may comprise capturing a facial feature of the person 355 by way of a camera 345 as biometric sensor of the smartphone 350, wherein the smartphone 350 determines the requested biometric information based on the captured facial feature such that the requested biometric information represents the captured facial feature of the person 355.

After the smartphone 350 has determined the requested biometric information, the smartphone 350 is able to send the requested biometric information, via the communication connection 340, to the smartphone 310 that originally requested the biometric information. The smartphone 310 subsequently determines the authorization indication information based on the obtained authorization information (for example represented by the QR code 315) and the biometric information received from the smartphone 350.

Advantageously, making the request to the smartphone 350 makes it possible to obtain biometric information representing a biometric feature of the third person 355. This third person 355 may be a person to whom the original recipient 335 of the stored shipment would like to transfer the collection of the stored shipment. By capturing a biometric feature from this third person 355 and then determining authorization indication information indicating that biometric information representing the biometric feature of the third person 355 authorizes collection of the shipment, the third person 355 is able to be flexibly authorized by the original recipient 335 of the conventional authorization information to collect the shipment. Advantageously, it is not necessary for the third person 355 to obtain the conventional authorization information (for example represented by the QR code 315) and to submit it when collecting the shipment at the locker installation. At the same time, the described transfer of the collection authorization is secure against attempted fraud, since the transfer is carried out via the smartphone 310 of the original recipient 335 of the conventional authorization information and is thus under the control of the original recipient 335, who is able to decide whether and from which further smartphone biometric information is requested.

FIG. 4 shows a flowchart of one exemplary embodiment of a method 400 according to the second aspect of the present disclosure. The method 400 is described below by way of example with reference to the system 1 illustrated in FIG. 1.

With regard to the system 1, the method 400 may be performed by the backend server 120 or by the control unit 131 of the locker installation 130. The method 400 may for example take place at a time after the method 200 illustrated in FIG. 2, that is to say after a person 140 with their smartphone 110 has captured at least one biometric feature of themselves and corresponding authorization indication information has been determined by the smartphone 110 and transmitted to the backend server 120. By way of example, the person 140 has then gone to the locker installation 130 in order to collect the shipment addressed to them and stored in the locker installation 130.

Step 401 is that of obtaining biometric information, wherein the biometric information represents at least one biometric feature of a person.

If the obtaining of biometric information is performed by the control unit 131 of the locker installation 130, the control unit 131 for example actuates a biometric sensor of the locker installation 130, such that it captures a biometric feature of the person 140. If a facial feature or a fingerprint was captured by a biometric sensor of the smartphone 110 from the person 140, as described above with regard to step 202 of the method 200 illustrated in FIG. 2, as biometric feature, this same biometric feature is likewise captured by a biometric sensor of the locker installation 130 in step 401.

If the obtaining of biometric information is performed by the backend server 120, the backend server 120 receives the biometric information from the control unit 131 of the locker installation 130 via the communication connection 125. Before the transmission of the biometric information, the biometric information is obtained at the control unit 131 by virtue of the biometric feature represented by the biometric information being captured by a biometric sensor of the locker installation 130.

Step 402 is that of determining whether the biometric information authorizes collection of a shipment.

If the determining whether the biometric information authorizes collection of a shipment is performed by the backend server 120, the backend server 120 determines for example whether, in a data memory of the backend server 120, authorization indication information is available indicating that the biometric information obtained in step 401 authorizes collection of a shipment. This available authorization indication information is the authorization indication information that was previously determined on the smartphone 110, as described with regard to the method 200 illustrated in FIG. 2, and then transmitted to the backend server 120.

By way of example, the determining in step 402 may comprise comparing the biometric information obtained in step 401 with a plurality of available pieces of biometric information in a data memory of the backend server 120. It is determined here whether the obtained biometric information matches one of the already available pieces of biometric information. If the obtained biometric information matches already available biometric information, it is then determined, by the backend server 120, whether authorization indication information is available indicating that the already available biometric information matching the obtained biometric information authorizes collection of a shipment. If such authorization indication information is available, it is determined in step 402 that the obtained biometric information authorizes collection of a shipment. In this case, the obtained biometric information may match available biometric information if the biometric feature represented by the obtained biometric information (in this case, for example, a facial feature or fingerprint of the person 140) matches the biometric feature represented by the available biometric information (for example within a predetermined tolerance).

In a further example, the determining in step 402 may be performed by the control unit 131 of the locker installation 130. The control unit 131 then determines for example whether, in a data memory of the control unit 131, authorization indication information is available indicating that the biometric information obtained in step 401 authorizes collection of a shipment. By way of example, the determining in step 402 as described above may comprise comparing the biometric information obtained in step 401 with a plurality of available pieces of biometric information. In this case, the already available pieces of biometric information may be stored in a data memory of the control unit 131 or be requested by the control unit 131 from the backend server 120, in response to which the requested already available biometric information is transmitted from the backend server 120 to the control unit 131 and compared with the obtained biometric information at the control unit 131. In another example, the determining in step 402 may comprise transmitting the obtained biometric information from the control unit 131 to the backend server 120, wherein the backend server 120 performs the comparison described above and then sends a result of the comparison back to the control unit 131. It may then be determined at the control unit 131, based on the received result of the comparison, that the biometric information obtained in step 401 authorizes collection of a shipment.

Step 403 is that of causing opening of a compartment of a locker installation in which the shipment is stored if it is determined that the biometric information authorizes collection of a shipment.

The opening is caused in step 403 when (for example only when) it is determined in step 402 that the obtained biometric information authorizes collection of a shipment. Otherwise, the control unit 131 may output information (for example via a user interface of the control unit 131) indicating that there is no shipment for collection in the locker installation 130 for the person 140 for whom the obtained biometric information represents a biometric feature.

If the opening is caused in step 403 by the control unit 131, the causing of the opening may comprise actuating a corresponding lock control unit of a compartment of the locker installation 130 in which the shipment in question is stored. The lock control unit is actuated here such that it opens the compartment of the locker installation 130 (for example by unlocking a lock of the compartment).

If the opening is caused in step 403 by the backend server 120, the causing of the opening may comprise the backend server 120 sending a command to the control unit 131 to open a specific compartment of the locker installation 130. In response thereto, the control unit 131 actuates a corresponding lock control unit so that the compartment is opened. Causing the opening in such a case may comprise the backend server 120 first determining the locker installation in which the shipment for which the obtained biometric information authorizes collection is stored, and then sending an opening command to the control unit 131.

After step 403, the pieces of biometric information obtained in steps 202 and 402 are deleted from the corresponding data memories (for example on the backend server 120 and/or the control unit 131).

According to the methods illustrated in FIG. 2 and FIG. 4, a person 140, as shipment recipient, may advantageously capture one or more biometric features of their person (for example a facial feature) by way of their smartphone 110 based on conventional authorization information, obtained in step 201, for the collection of a shipment, in step 202. In response thereto, the smartphone 110 determines, in step 203, that, in addition or as an alternative to the conventional authorization information, biometric information representing the captured biometric feature authorizes collection of the shipment. The smartphone 110 transmits, in step 204, corresponding biometric information and authorization indication information to a backend server 120 that is in communication with the locker installation 130 in which the shipment is stored. The person 140 may then accordingly, at the locker installation 130 in question, have this biometric feature captured by corresponding sensors of the locker installation 130 in step 401, such that the corresponding shipment is issued in step 403 following an inspection in step 402. It is thus advantageously no longer necessary to carry and submit the conventional authorization information at the locker installation 130 in order to issue the stored shipment.

Instead of conventional authorization information, it is advantageously sufficient, in situ at the locker installation, to capture a biometric feature in order to collect a stored shipment, such that the person 140 does not have to carry any additional pieces of information or proof in order to collect the shipment in question. Advantageously, the biometric information may authorize collection of a specific shipment, such that said information is able to be deleted from all data memories (for example data memories of the control unit 131 of the locker installation 130 or of the backend server 120) after this shipment has been collected. This thus advantageously ensures that the (for example sensitive) biometric information is stored only temporarily up to the time of shipment collection.

FIG. 5 shows a schematic illustration of one exemplary environment in which a method according to the second aspect of the present disclosure takes place.

For example, the locker installation 5 illustrated in FIG. 5 comprises a control unit 510 that controls the functions of the locker installation 5. The locker installation 5 may be a locker installation 130 of the system 1 illustrated in FIG. 1, wherein one exemplary embodiment of the control unit 510 may be embodied by the control unit 8 illustrated in FIG. 8.

In addition, the locker installation 5 comprises a plurality of compartments 520 that are configured for example to receive shipments (for example letters, parcels, packages) or deliveries or items (for example items of value, luggage, etc.). At least some of the compartments 520 are lockable in each case by way of a respective door or flap. At least some of the compartments 520 are provided with a respective lock in order to be able to control access to these individual compartments 520 of the locker installation 5 for people.

The lock of a respective compartment 520 is controllable by the control unit 510, in particular in electronic form. In particular, the control unit 510 may control at least the process of locking and/or unlocking the lock and thus closing and/or opening the respective compartment 520. The lock of a compartment 520 may be controlled by a lock control unit, for example, wherein all of the lock control units or those of one or more modules of the locker installation 5 are controlled for example by the superordinate control unit 510 of the locker installation 5.

The locker installation 5 furthermore comprises a biometric sensor, which is embodied for example by the camera 530. The camera 530 for example captures images of a face of the person 540 from different angles and distances, such that the control unit 510 of the locker installation 5 is able to determine one or more facial features of the person 540 based on the captured images, for example by way of image processing (for example an image analysis algorithm). Furthermore, the camera 530 (for example in the form of an infrared camera) of the locker installation 5 may capture a three-dimensional shape of the face of the person 540, for example by virtue of a dot pattern first being projected onto the face and the camera then capturing the reflected dot pattern.

In the environment illustrated by way of example in FIG. 5, for example, the method 400 illustrated in FIG. 4 may take place as described below.

By way of example, the control unit 510 actuates the camera 530 of the locker installation 5 such that the camera 530 captures a facial feature of the person 540 (cf. step 401). The person 540 is the recipient of the shipment 550 stored in the locker installation 5. Based on the captured facial feature, the control unit 510 then determines biometric information representing the facial feature.

In a next step (cf. step 402), the control unit 510 determines whether, in a data memory of the control unit 510, authorization indication information is available indicating that the previously obtained biometric information authorizes collection of a shipment. By way of example, this determining may comprise comparing the obtained biometric information with a plurality of available pieces of biometric information that may be stored in a data memory of the control unit 510 or may be requested by the control unit 510 from a backend server.

If the control unit 510 determines that the obtained biometric information authorizes collection of a shipment, it causes opening of the compartment of the locker installation 5 in which the shipment 550 is stored (cf. step 403).

FIG. 6 shows a flowchart of one exemplary embodiment of a method 600 according to the third aspect of the present disclosure. The method 600 is described below by way of example with reference to the system 1 illustrated in FIG. 1.

With regard to the system 1, the method 600 may be performed by the backend server 120. Steps 601 to 603 may accordingly be understood as corresponding to the steps of the method 200 illustrated in FIG. 2 and of the method 400 illustrated in FIG. 4.

Step 601 is that of providing authorization information, wherein the authorization information authorizes collection of a shipment from a locker installation.

The providing in step 601 should be understood to mean that the backend server 120 makes the authorization information available to the person 140 (for example the recipient of the shipment for which the authorization information authorizes collection), such that the person 140 is authorized to collect the shipment from the locker installation 130 by way of the authorization information. By way of example, the backend server 120 sends the authorization information to the smartphone 110 of the person 140 to be authorized via the communication connection 115. In a further example, the backend server 120 sends the authorization information to a portable delivery agent device (for example the delivery agent device of the delivery agent that previously stored the shipment in question in the locker installation 130). In such a case, the authorization information may be printed for example in the form of a barcode by the delivery agent device (for example a hand-held device equipped with a scanner and printer), wherein the printed barcode (for example printed on a collection card) is then inserted by the delivery agent into a letterbox of the person 140.

Step 602 is that of obtaining authorization indication information and biometric information, wherein the authorization indication information is determined, before the obtaining, at least partially based on the authorization information and the biometric information, and wherein the authorization information indicates that the biometric information authorizes collection of the shipment from the locker installation.

By way of example, the authorization information provided by the backend server 120 in step 601 is obtained on the smartphone 110 as described with regard to the method 200 illustrated in FIG. 2 for step 201. Accordingly, authorization indication information is determined at a later point in time on the smartphone 110 based on the authorization information obtained in step 201 and the biometric information obtained in step 202. This authorization indication information, together with the biometric information, is transmitted back from the smartphone 110 to the backend server 120, such that the authorization indication information and the biometric information are obtained on the backend server 120 in step 602.

Step 603 is that of providing the authorization indication information and the biometric information.

The authorization indication information and biometric information provided in step 603 may be understood hereinafter as available biometric information and as available authorization indication information.

The providing in step 603 may comprise storing these pieces of information in a data memory of the backend server 120. In a further example, the providing in step 603 may comprise these pieces of information being sent to the control unit 131 of the locker installation 130, wherein these pieces of information are then stored in a data memory of the control unit 131. For this purpose, the backend server 120 may first determine the locker installation 130 in which the shipment for which the authorization indication information indicates that the biometric information authorizes collection has been stored beforehand. The backend server 129 may then send both pieces of information to the control unit 131 of the determined locker installation 130. At this locker installation, a method 400 as illustrated in FIG. 4 may be carried out thereafter, in the course of which the stored shipment is collected.

FIG. 7 shows a schematic illustration of one exemplary embodiment of a user device 7 according to the first aspect of the present disclosure. The user device 7 may be for example a smartphone, that is to say in particular a mobile telephone with the ability to independently execute more complex programs, what are known as apps. The user device 7 may for example represent the smartphone 110 as part of the system 1 illustrated in FIG. 1.

The user device 7 comprises a processor 70, a program memory 71, a main memory 72, an application data memory 73, a communication interface 74, an image recording device 75, at least one biometric sensor 76 and a user interface 77.

The processor 70 executes for example a program according to the first aspect of the present disclosure, which program is stored in the program memory 71, for example in the form of an app or firmware. The main memory 72 serves in particular for storing temporary data during the execution of this program. The application data memory 73 serves for storing data required during the processing of the program. These data may be for example pieces of biometric information and authorization information.

The communication interface 74 comprises for example one or more interfaces allowing the user device to communicate with at least one further device (for example with the backend server 120 as part of the system 1 illustrated in FIG. 1). The communication interface 74 may in particular be configured such that it communicates in accordance with a cellular mobile radio system such as a 2G/3G/4G/5G or future cellular mobile radio system. Furthermore, the communication interface 74 may additionally comprise a BLE and/or Bluetooth radio interface having a BLE transmitter and/or receiver. For example, the radio interface 74 may, in addition or as an alternative, comprise a WLAN radio interface having at least one WLAN transmitter and/or receiver.

The image recording device 75 may be embodied by a camera of the user device 7, for example by a rear camera of a smartphone as user device 7. The image recording device 75 may also at the same time be for example a biometric sensor 76, described below, of the user device 7.

The at least one biometric sensor 76 may take a variety of forms. The biometric sensor 76 may be embodied by a camera (for example a camera that serves at the same time as image recording device 75), wherein the camera for example captures images of a face from different angles and distances. Furthermore, a camera (for example an infrared camera), as biometric sensor 76, may capture a three-dimensional shape of a face, for example by virtue of a dot pattern first being projected onto the face and the camera then capturing the reflected dot pattern. The biometric sensor 76 may also be embodied by a fingerprint sensor (which for example comprises one or more image sensors, capacitive sensors, thermal sensors and/or pressure sensors). The biometric sensor 76 may also be embodied by a microphone, wherein the microphone for example picks up a spoken voice and the picked-up audio signals are analyzed by way of audio processing in order to determine characteristic vocal features such as pitch or frequency patterns.

The user device 7 may have any number of different biometric sensors 76, which may be arranged differently on the user device 7.

The user interface 77 may be designed as a screen and keypad or as a touch-sensitive display (touch screen) and for example enable a user of the user device 7 to operate the user device.

FIG. 8 shows a schematic illustration of one exemplary embodiment of a control unit 8 of a locker installation (for example of the locker installation 130 illustrated in FIG. 1 or of the locker installation 5 illustrated in FIG. 5) according to the second aspect of the present disclosure.

The control unit 8 comprises a processor 80, a program memory 81, a main memory 82, an application data memory 83, a communication interface 84, an actuation unit 85 for the locks or lock control units of the compartments of the locker installation, at least one biometric sensor 86 and an optional input unit/user interface 87. The processor 80 executes for example a program according to the second aspect of the present disclosure, which program is stored in the program memory 81, for example as firmware. The main memory 82 serves in particular for storing temporary data during the execution of this program.

The application data memory 83 serves for storing data required during the processing of the program. In the present case, these data may for example be pieces of information able to be used by the control unit 8 to identify whether biometric information authorizes collection of a shipment from the locker installation. Further data, such as for example shipping information, may be stored for example in the application data memory 83, for example in data structures that represent an assignment of stored shipments, pieces of authorization information and/or respective compartments of the locker installation.

The communication interface 84 comprises for example an interface for wireless communication, for example by way of optical transmission and/or by way of communication based on electrical, magnetic or electromagnetic signals or fields, in particular on Bluetooth, NFC and/or RFID. The control unit 8 is for example furthermore configured for direct communication with a backend server (for example the backend server 120 shown in FIG. 1), that is to say has for example a communication interface that enables access to the Internet or to some other network to which the backend server is connected.

The actuation unit 85 of the control unit 8 of a locker installation makes it possible to open or to unlock an individual compartment of the locker installation in a targeted manner in order to enable the opening, in particular by actuating the lock of the compartment or a lock control unit of the compartment. Locking of a respective compartment may additionally be caused. Via a respective wiring, for example, the actuation unit 85 is connected to all of the locks or lock control units of the locker installation or is connected to a bus to which all of the locks or lock control units of the locker installation are also linked.

The at least one biometric sensor 86 may take a variety of forms. The biometric sensor 86 may be embodied by a camera, connected to the control unit 8, of the locker installation, wherein the camera for example captures images of a face from different angles and distances. Furthermore, a camera (for example an infrared camera), as biometric sensor 86, may capture a three-dimensional shape of a face, for example by virtue of a dot pattern first being projected onto the face and the camera then capturing the reflected dot pattern. The biometric sensor 86 may also be embodied by a fingerprint sensor of the control unit 8 (which fingerprint sensor for example comprises one or more image sensors, capacitive sensors, thermal sensors and/or pressure sensors). The biometric sensor 86 may also be embodied by a microphone of the control unit 8, wherein the microphone for example picks up a spoken voice and the picked-up audio signals are analyzed by way of audio processing in order to determine characteristic vocal features such as pitch or frequency patterns.

The control unit 8 of a locker installation may have any number of different biometric sensors 86, which may be arranged differently on the locker installation. For example, a camera, as biometric sensor 86, is arranged on the locker installation such that it is able to capture the face of a person using the locker installation. A fingerprint sensor, as biometric sensor 86, is arranged for example on the front of the locker installation such that it is easily accessible for a person using the locker installation.

The input unit/user interface 87 is optional and configured for communication with a delivery agent/deliverer and/or a user. This may comprise for example an output unit for displaying (for example via a screen or via compartment-specific luminous displays) or acoustically outputting pieces of information and/or a unit for obtaining pieces of information and/or data (for example a keypad or a touch-sensitive screen with a screen keypad or a voice recognition module).

The control unit 8 may furthermore have a capture unit, such as for example a scanner, that is able to capture pieces of information optically (for example a barcode or QR code from a screen of a mobile device). In a further example, a capture unit of the control unit is configured to read NFC tags, which are attached for example to a respective shipment and/or inserted therein. The capture unit may, in addition or as an alternative, be capable of capturing and processing acoustic signals (for example by way of voice recognition).

FIG. 9 shows a schematic illustration of one exemplary embodiment of a backend server 9 according to the second or third aspect of the present disclosure. The backend server 9 may for example be a locker installation management server.

The backend server 9 comprises a processor 90, a program memory 91, a main memory 92, an optional application data memory 93 and at least one communication interface 94. The processor executes for example a program according to the second aspect of the present disclosure, which program is stored in the program memory 91, for example as firmware. The main memory 92 serves in particular for storing temporary data during the execution of this program.

The application data memory 93 serves for storing data required during the processing of the program. In the present case, these data may for example be pieces of information able to be used by the backend server 9 to identify whether biometric information authorizes collection of a shipment from the locker installation. Further data, such as for example shipping information, may be stored for example in the application data memory 93, for example in data structures that represent an assignment of stored shipments, pieces of authorization information and/or respective compartments of a locker installation. These data may also be for example user identifiers, user contact data, such as e-mail addresses and mobile radio numbers, locker installation identifiers and shipment data. All data may be stored for example in encrypted form. In addition, the application data memory 93 may store pieces of information about a plurality of locker installations.

The at least one communication interface 94 may be an interface configured for communication with a control unit of a locker installation (for example the control unit 131 of the locker installation 130 illustrated in FIG. 1) or a mobile device (for example the smartphone 110 of the user 140 illustrated in FIG. 1). This communication may be based on the Internet Protocol (IP), for example. For example, for this purpose, the at least one communication interface 94 is designed as a local area network (LAN) interface.

In the exemplary embodiments in FIGS. 7 to 9, the processor 70, 80 or 90 may be for example in each case a control unit, a microprocessor, a microcontrol unit such as a microcontroller, a digital signal processor (DSP), an application-specific integrated circuit (ASIC) or a field-programmable gate array (FPGA). In the exemplary embodiments in FIGS. 7 to 9, the program memory and/or the application data memory may be for example a persistent memory, such as for example a read-only memory (ROM). The program memory may for example be fixedly connected to the respective processor 70, 80 or 90, but may alternatively also be releasably connected to the respective processor 70, 80 or 90, for example as a memory card, a floppy disk or an optical data carrier medium (for example a CD or DVD). The main memory of the exemplary embodiments in FIGS. 7 to 9 is used for example for storing temporary results during the processing of the program instructions, and is for example a volatile memory, such as for example a random access memory (RAM).

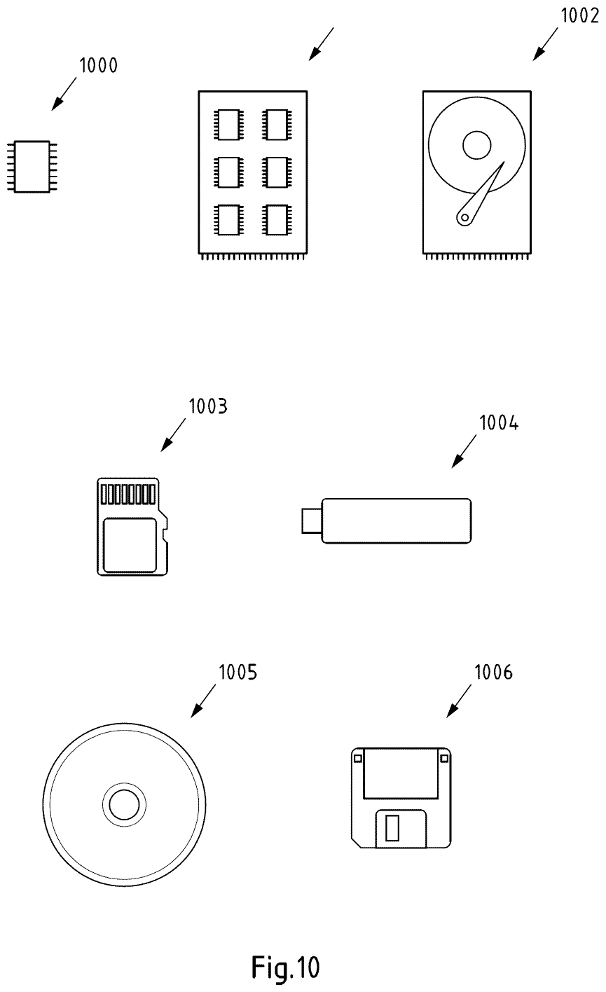

FIG. 10 shows exemplary embodiments of storage media on which for example a computer program according to the various aspects of the present disclosure may be stored. The storage medium may be for example a magnetic, electrical, optical and/or other storage medium. The storage medium may be for example part of a processor, for example a (non-volatile or volatile) program memory of the processor or a part thereof. Exemplary embodiments of a storage medium are a flash memory 1000, an SSD hard disk 1001, a magnetic hard disk 1002, a memory card 1003, a memory stick 1004 (for example a USB stick), a CD-ROM or DVD 1005 or a floppy disk 1006.

The exemplary embodiments of the present invention described in this specification are also intended to be understood as having been disclosed in all combinations with one another. In particular, the description of a feature that an embodiment comprises should also not-unless explicitly stated to the contrary-be understood in the present case to mean that the feature is indispensable or essential for the function of the exemplary embodiment. The sequence of the method steps outlined in this specification in the individual flowcharts is not mandatory; alternative sequences of the method steps are conceivable-unless indicated otherwise. The method steps may be implemented in various ways, and so implementation using software (by way of program instructions), hardware or a combination of the two is conceivable for implementing the method steps.

Terms used in the patent claims such as “comprise”, “have”, “include”, “contain” and the like do not exclude further elements or steps. The wording “at least partially” includes both the case of “partially” and the case of “completely”. The wording “and/or” is intended to be understood to mean that both the alternative and the combination are intended to be disclosed, that is to say “A and/or B” means “(A) or (B) or (A and B)”. In the context of this specification, a plurality of units, persons or the like means several units, persons or the like. The use of the indefinite article does not exclude a plurality. A single device may perform the functions of a plurality of units or devices mentioned in the patent claims. Reference signs indicated in the patent claims should not be regarded as limitations for the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method, wherein the method comprises:
obtaining authorization information, wherein the authorization information authorizes collection of a shipment from a locker installation;
obtaining biometric information, wherein the biometric information represents at least one biometric feature of a person;
determining authorization indication information, at least partially based on the authorization information and the biometric information, wherein the authorization indication information indicates that the biometric information authorizes collection of the shipment from the locker installation; and
providing the authorization indication information and the biometric information.

2. The method according to claim 1, wherein the authorization information is represented by a collection code.

3. The method according to claim 1, wherein the obtaining of the authorization information comprises:
receiving the authorization information from a backend server; or
causing capturing of the authorization information by an image recording device of a user device.

4. The method according to claim 1, wherein the obtaining of the biometric information comprises:
causing capturing of the at least one biometric feature represented by the biometric information by one or more biometric sensors of the user device.

5. The method according to claim 1, wherein the obtaining of the biometric information comprises:
requesting the biometric information from a further user device;
receiving the requested biometric information from the further user device.

6. The method according to claim 1, wherein the providing of the authorization indication information and of the biometric information comprises:
transmitting the biometric information and the authorization indication information to a backend server.

7. A method comprising:
obtaining biometric information, wherein the biometric information represents at least one biometric feature of a person;
determining whether the biometric information authorizes collection of a shipment; and
if it is determined that the biometric information authorizes collection of a shipment, causing opening of a compartment of a locker installation in which the shipment is stored.

8. The method according to claim 7, wherein the obtaining of the biometric information comprises:
causing capturing of the at least one biometric feature represented by the biometric information by one or more biometric sensors of the locker installation.

9. The method according to claim 7, wherein the determining whether the biometric information authorizes collection of a shipment comprises:
determining whether authorization indication information is available indicating that the obtained biometric information authorizes collection of a shipment.

10. The method according to claim 7, wherein causing the opening of the compartment comprises:
determining, at least partially based on the available authorization indication information, the compartment of the locker installation in which the shipment authorized for collection by the biometric information is stored.

11. A method, wherein the method comprises:
providing authorization information, wherein the authorization information authorizes collection of a shipment from a locker installation;
obtaining authorization indication information and biometric information, wherein the authorization indication information is determined, before the obtaining, at least partially based on the authorization information and the biometric information, and wherein the authorization information indicates that the biometric information authorizes collection of the shipment from the locker installation; and
providing the authorization indication information and the biometric information.

12. The method according to claim 11, wherein the providing of authorization information comprises transmitting the authorization information to a user device, wherein the obtaining of authorization indication information and biometric information comprises receiving the authorization indication information and the biometric information from the user device, and wherein the providing of the authorization indication information and of the biometric information comprises transmitting the authorization indication information and the biometric information to a control unit of a locker installation.

13. The method according to claim 1, wherein the at least one biometric feature of the person is a facial feature of the person.

14. A computer program, comprising program instructions that cause a processor to perform and/or control the method according to claim 1 when the computer program runs on the processor.

15. A user device configured to perform and/or control the method according to claim 1 or comprising means for performing and/or controlling the steps of the method according to claim 1.

16. A device configured to perform and/or control the method according to claim 7 or comprising means for performing and/or controlling the steps of the method according to claim 7.

17. A backend server, configured to perform and/or control the method according to claim 11 or comprising means for performing and/or controlling the steps of the method according to claim 11.

18. A system comprising:
a user device;
a device;
a backend server;
wherein, the backend server is configured to perform and/or comprises means for performing:
providing authorization information, wherein the authorization information authorizes collection of a shipment from a locker installation;
obtaining authorization indication information and biometric information,
providing the authorization indication information and the biometric information;
wherein, the user device is configured to perform and/or comprises means for performing:
obtaining the authorization information,
obtaining the biometric information, wherein the biometric information represents at least one biometric feature of a person;
determining authorization indication information, at least partially based on the authorization information and the biometric information, wherein the authorization indication information indicates that the biometric information authorizes collection of the shipment from the locker installation; and
providing the authorization indication information and the biometric information;
wherein the device is configured to perform and/or comprises means for performing:
obtaining the biometric information,
determining whether the biometric information authorizes collection of a shipment; and
if it is determined that the biometric information authorizes collection of a shipment, causes opening of a compartment of the locker installation in which the shipment is stored.
